(19) United States
(12) Patent Application Publication
(10) Pub. No.: US 2009/0047405 A1
(43) Pub. Date: Feb. 19, 2009

(54) FOOD COMPOSITION WITH THERAPEUTIC AGENTS

(75) Inventor: Shi-Qiu Zhang, Englewood Cliffs, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 11/839,968

(22) Filed: Aug. 16, 2007

(51) Int. Cl. A23L 1/09; A23F 3/14; A23L 1/30

(52) U.S. Cl. 426/533; 426/442; 426/557; 426/567; 426/589; 426/590; 426/597; 426/618; 426/648; 426/650; 426/655; 426/658

(57) ABSTRACT

Food compositions with therapeutic agents are described. The food compositions comprise oligosaccharides and/or polysaccharides that are fractions recovered from North American Ginseng. The food compositions can be tea beverages that have improved taste characteristics and that can provide enhanced immunity when consumed.

### FIELD OF THE INVENTION

The present invention is directed to a food composition comprising a therapeutic agent. More particularly, the present invention is directed to a food composition comprising a therapeutic agent that comprises an oligo- and/or polysaccharide fraction that can be isolated from plant or herb root. The food composition of the present invention is surprisingly stable, notwithstanding the addition of therapeutic agent, and has less bitter notes than similar unsweetened and unflavored food compositions formulated without the therapeutic agent.

### BACKGROUND OF THE INVENTION

Excluding water, tea is the most popular beverage consumed by man. Tea is very refreshing, can be served either hot or cold, and has been made commercially available for many years. Lipton®, for example, is the world's leading brand of tea, made available in over 110 countries by Unilever.

Today, modern scientists are exploring the exciting potential of tea, which has a unique combination of natural antioxidants known as flavonoids that can include flavanols (such as catechins), flavonols, flavonol glucosides and the like. Taken regularly, tea can help improve vascular function, combat fatigue, reduce cholesterol levels and increase feelings of vitality.

Notwithstanding the many positive attributes found in food compositions, like tea, there is an increasing interest to develop a food composition that has therapeutic properties and is suitable to target conditions characterized by low immunity such as the common cold and influenza. Particularly, there is interest in improving food compositions to maximize consumer benefits without negatively impacting the stability and consumer accepted taste characteristics of the same. This invention, therefore, is directed to a food composition comprising a therapeutic agent that comprises an oligo- and/or polysaccharide fraction that can be isolated from plant or herb root. The food composition of the present invention is surprisingly stable, even with the addition of a therapeutic agent, and has less bitter notes than similar unsweetened and unflavored food compositions formulated without the therapeutic agent.

Additional Information

Efforts have been disclosed for describing healthy food compositions. In WO 2006/048122 A1, consumable compositions with antioxidants are described.

Other efforts have been disclosed for making healthy food compositions. In U.S. Pat. No. 5,770,248, reduced fat shredded wafers are described.

Still other efforts have been disclosed where therapeutic agents are prepared. In U.S. Pat. No. 6,432,454, a process for making immunomodulators from North American Ginseng fractions is described.

None of the additional information above describes a stable food composition, like a tea beverage, that comprises a therapeutic agent comprising an oligo- and/or polysaccharide fraction that can be isolated from plant or herb root where the food composition has less bitter notes than similar unsweetened and unflavored food compositions formulated without the therapeutic agent.

### SUMMARY OF THE INVENTION

In a first aspect, the present invention is directed to a food composition precursor comprising a therapeutic agent, the therapeutic agent comprising an oligosaccharide, a polysaccharide or both, with the proviso that the therapeutic agent is not simultaneously free of oligosaccharide and free of polysaccharide comprising rhamnose and arabinose.

In a second aspect, the present invention is directed to a food composition made with the precursor of the first aspect of this invention.

In a third aspect, the present invention is directed to a method for delivering therapeutic agent to a consumer with the food composition of the second aspect of this invention.

In a fourth aspect, the present invention is directed to a method for reducing the bitterness of a food composition by formulating the food composition with a therapeutic agent.

All other aspects of the present invention will more readily become apparent upon considering the detailed description and examples which follow.

Therapeutic agent, as used herein, is meant to mean a product suitable to stimulate the production of cytokines and/or antibodies, or therapeutics targeted at conditions characterized by low immunity, such as the common cold and influenza. Such a therapeutic agent comprises an oligosaccharide comprising rhamnose and arabinose, a polysaccharide comprising rhamnose and arabinose, or both. Therapeutic agents which are unexpectedly suitable for use in this invention have been studied and reports show they appear to enhance macrophage and B lymphocyte functions, and therefore, can potentially initiate acquired immune responses and prevent certain illnesses like acute respiratory illness caused by influenza (all of which is described in McElhaney et al., A Placebo-Controlled Trial of a Proprietary Extract of North American Ginseng (CVT-E002) to Prevent Acute Respiratory Illness in Institutionalized Older Adults, JAGS. 2004, Vol. 42, No. 1, pp. 13-20, and Wang et al., A proprietary extract from North American ginseng (Panax quinquefolium) enhances IL-2 and IFN-γproductions in murine spleen cells induced by Con-A, International Immunopharmacology, 4 (2004), pp. 311-315, the disclosures of which are incorporated herein by reference). Food composition precursor, as used herein, is meant to mean a precursor composition suitable to use for making a food composition. Food composition is meant to mean a food product ready to consume, like, for example, a beverage (such as coffee, hot chocolate, fruit juice, energy drink, or a tea beverage), spread, sauce, dip, spoonable dressing, ice cream, pasta-based composition, wheat-based composition, meal supplement or replacement drink, or a meal supplement or replacement bar. Total saccharide means the total amount of carbohydrate, including oligosaccharide and/or polysaccharide, present within the therapeutic agent. Stable, as used herein, means having no negative change in appearance when compared to similar compositions free of therapeutic agent, and in the case of a tea beverage, having no visual precipitate and a turbidity of less than about 75 nephelometric turbidity units (NTU), and preferably less than about 55 NTU, and most preferably, less than about 35 NTU when the beverage has been stored at ambient temperature for about a three (3) month period after formulating. Less bitter means less astringent and less after taste when compared to similar unsweetened and unflavored food compositions formulated without therapeutic agent.

In a preferred embodiment, the food composition of this invention is a tea beverage where tea beverage preferably means a beverage with tea solids such as a beverage with green tea solids, black tea solids, white tea solids, oolong tea solids or mixtures thereof. In yet another preferred embodiment, the food composition is a tea beverage comprising from about 0.01 to about 0.8%, and preferably, from about 0.02 to about 0.6%, and most preferably, from about 0.08 to about 0.5% by weight tea solids, based on total weight of food composition and including all ranges subsumed therein. The term comprising is meant to include consisting essentially of and consisting of.

### DETAILED DESCRIPTION OF THE PREFERRED EMBODIMENT

As to the therapeutic agents which may be used in this invention, the only limitation with respect to the same is that the therapeutic agent is one which comprises an oligosaccharide or a polysaccharide or both and the therapeutic agent is not simultaneously free of oligosaccharide and polysaccharide comprising rhamnose and arabinose.

In a preferred embodiment, the therapeutic agent employed in this invention comprises at least about 0.45% rhamnose and at least about 10.5% arabinose, and preferably, from about 0.5 to about 8.5% rhamnose and from about 11 to about 25% arabinose, based on mol percent of total saccharide and including all ranges subsumed therein.

In addition to rhamnose and arabinose, it is especially preferred that the therapeutic agent having oligosaccharide and/or polysaccharide further comprises from about 10.5 to about 49% galacturonic acid, from about 1.5 to about 60% glucose, and from about 9.5 to about 33% galactose, based on mol percent of total saccharide and including all ranges subsumed therein.

The most preferred therapeutic agent employed in this invention is one typically recovered from North American Ginseng Fractions (Panax quinquefolium) and classified as an extract comprising polyfuranosyl-pyranosyl-saccharides. Generally, North American Ginseng may be treated with a solvent comprising alcohol and heated to produce a ginseng solution. Ginseng residue may be removed from the ginseng solution and combined with water to produce a residue solution. The residue solution may be separated to produce a second ginseng residue and an aqueous extract solution with ginseng extract. The aqueous extract solution may be dried to recover the desired ginseng fractions (i.e., therapeutic agent comprising oligosaccharide and/or polysaccharide with the specific saccharide content identified above).

A more detailed description of the production of the preferred therapeutic agents that may be used in this invention may be found in U.S. Pat. No. 6,432,454, the disclosure of which is incorporated herein by reference.

The most preferred therapeutic agents which may be used in this invention often have oligosaccharide and/or polysaccharide such that the total saccharide content of the therapeutic agent having the oligosaccharide and/or polysaccharide present is:

| | Mol. % | |
|---|---|---|
| I. | 2-6 | rhamnose |
| | 41-49 | galacturonic acid |
| | 12-18 | glucose |
| | 16-22 | galactose |
| | 12-19 | arabinose, |
| II. | 3-8 | rhamnose |
| | 36-44 | galacturonic acid |
| | 2-7 | glucose |
| | 25-33 | galactose |
| | 17-25 | arabinose or |
| III. | 0.5-5 | rhamnose |
| | 11-22 | galacturonic acid |
| | 40-60 | glucose |
| | 10-19 | galactose |
| | 11-19 | arabinose, |

where mol % is based on total saccharide.

It is also within the scope of this invention for mixtures of the preferred therapeutic agents to be used in the food composition precursor and food composition of this invention. Furthermore, therapeutic agents suitable for use in this invention are commercially available, and sold, for example, in capsule form under the name COLD-fx® or CVT-E002, made available by C.V. Technologies, Inc.

The food composition precursors described in this invention are preferably precursors that are suitable to be used to make a tea beverage. Such precursors can be in any suitable form as long as the desired food composition can be prepared therefrom.

Often, however, the food composition precursor is a powder, concentrate or extract, or tea bag. When making the precursor of this invention, typically a commercially available precursor may be purchased and the therapeutic agent may be added thereto, preferably in powder form. Such commercially available precursors, especially when the food composition desired is a tea beverage, can be obtained from suppliers, like Unilever, under the Lipton® Tea Brand.

When preparing food composition according to this invention, therapeutic agent may be added directly to commercially available food composition precursor, to food composition or both.

In a preferred embodiment, however, therapeutic agent (in powder form) is added to food composition precursor. Of course, when the food composition precursor is tea leaf to be packaged in a tea bag or used with filter paper, therapeutic agent can be reformed so that particles of the same can be made larger to prevent the therapeutic agent from passing through the filter paper prior to dissolving in a solvent like water.

Often, the amount of therapeutic agent added to the food composition precursor, is from about 2 to about 12%, and preferably, from about 3 to about 10%, and most preferably, from about 4 to about 9%, based on total weight of the food composition precursor, including all ranges subsumed therein.

When preparing the desired food composition, especially a tea beverage, the food composition precursor may be diluted or infused with water to produce a tea beverage. The food composition prepared typically comprises from about 0.015 to about 0.15%, and preferably, from about 0.02 to about 0.1%, and most preferably, from about 0.03 to about 0.07% by weight therapeutic agent, based on total weight of the food composition and including all ranges subsumed therein. The process of incorporating therapeutic agent into a food composition as described herein not only results in a composition with potential health benefits but also, and unexpectedly, results in a food composition with reduced bitter notes.

A more detailed description of the types of precursors that may be combined with therapeutic agents suitable for use in this invention can be found in U.S. Pat. Nos. 6,780,454 and 6,413,570, and U.S. Patent Application Publication Nos. 2007/0122539A1 and 2006/0177559A1, the disclosures of which are incorporated herein by reference.

Optional but often preferred additives may be used in the food composition precursors and food compositions described herein. For example, catechins (e.g., isolated from tea solids) including epigallocatechin gallate (EGCG), epicatechin (EC) epicatechin gallate (ECG) and epigallocatechin (EGC) may be added to the precursors or food compositions described herein. Often, and especially when the food composition is a tea beverage, enough catechin may be added (to precursor and/or tea beverage or food composition) to produce a beverage with at least about 0.0125%, and preferably, at least about 0.035%, and most preferably, from about 0.05 to about 0.09% by weight catechin, based on total weight of the tea beverage or food composition, including all ranges subsumed therein.

Other optional additives which may be used in this invention include chelator (e.g., EDTA), sequestering agent (e.g., sodium hexametaphosphate), colorant, filler (like a dextrin-based compound), preservative, flavor, vitamin, sweetener, fruit juices, surfactant (like sorbitan monolaurate and sorbitan monopalmitate), acidulant (to stabilize pH between about 2.5 to about 5), antifoam or the like.

Still other optional additives which may be used in this invention include herb and nutrient blends like those that comprise at least one of lonicera, forsythia, schizonepeta, ginger, Chinese vitex, isatis root, echinacea or any combination thereof. Amino acids like theanine, glutamine and lysine may also be used. When employed, such optional additives, collectively, make up less than about 25.0% by weight of the total weight of the food composition.

The packaging for the food compositions made according to this invention is limited only to the extent that it is acceptable to the everyday consumer. Such packaging can include bottles (glass or PET), cans or standard drink pouches or boxes.

When consumed by an individual, the food composition of this invention successfully delivers therapeutic agent to the individual. Therefore, it is within the scope of this invention for the food composition precursor and/or the food composition to be used as a medicament. Particularly, the food composition precursor and/or food composition may be used in the manufacture of a medicament for the treatment or prevention of a condition characterized by low immunity, such as the common cold and/or influenza.

The examples which follow are provided to facilitate an understanding of the present invention. The examples are not intended to limit the scope of the claims.

### EXAMPLE 1

An unsweetened and unflavored green tea beverage (control) was prepared by combining 0.2% by weight green tea powder and 99.8% by weight water. The green tea powder contained about 25% by weight catechin and was prepared via a method similar to the one described in U.S. Published Patent Application No. 2006/0177559 A1. The resulting beverage had no visible solids subsequent to stirring.

An unsweetened and unflavored green tea beverage was made according to this invention whereby 99.75% by weight water was added to a mixture of green tea powder and CVT-E002 (therapeutic agent as described in U.S. Pat. No. 6,432,454 B1). The mixture was prepared so that the resulting tea beverage had 0.2% by weight green tea powder and 0.05% by weight CVT-E002 dissolved therein. The beverage had no visible solids subsequent to stirring.

### EXAMPLE 2

Panelists were given samples of each beverage prepared in Example 1. The panelists were asked to sample one beverage and then to wait about three (3) minutes before sampling the second food composition (i.e., beverage) made according to this invention. Over 65% of the panelists unexpectedly concluded that the food composition made according to this invention was less bitter than the control with no therapeutic agent.

What is claimed is:

1. A food composition precursor comprising a therapeutic agent, the therapeutic agent comprising an oligosaccharide, a polysaccharide or both, with the proviso that the therapeutic agent is not simultaneously free of oligosaccharide and free of polysaccharide comprising rhamnose and arabinose.

2. The food composition precursor according to claim 1 wherein the precursor comprises tea solids.

3. The food composition precursor according to claim 1 wherein the precursor is used to make green tea, black tea, white tea or oolong tea beverage.

4. The food composition precursor according to claim 1 wherein the therapeutic agent is extracted form North American Ginseng.

5. A food composition comprising a therapeutic agent, the therapeutic agent comprising an oligosaccharide, polysaccharide, or both, with the proviso that the therapeutic agent is not simultaneously free of oligosaccharide and polysaccharide comprising rhamnose and arabinose.

6. The food composition according to claim 5 wherein the food composition is a beverage, spread, sauce, dip, spoonable dressing, ice cream, pasta-based composition, wheat-based composition, meal supplement or replacement drink, or meal supplement or replacement bar.

7. The food composition according to claim 5 wherein the food composition is a tea beverage.

8. The food composition according to claim 6 wherein the tea beverage is a black, green, white or oolong tea beverage.

9. The food composition according to claim 5 wherein the therapeutic agent suppresses respiratory illness.

10. The food composition according to claim 5 wherein the therapeutic agent makes up from about 0.015 to about 0.15% by weight of the food composition.

11. The food composition according to claim 5 wherein the food composition comprises at least about 0.0125% by weight catechin.

12. The food composition according to claim 11 wherein the food composition is less bitter with the therapeutic agent than without the therapeutic agent.

13. The food composition according to claim 5 wherein the therapeutic agent is extracted from North American Ginseng.

14. The food composition according to claim 5 wherein the therapeutic agent comprises at least about 0.45% rhamnose and at least about 10.5% arabinose based on mole % of total saccharide in the therapeutic agent.

15. The food composition according to claim 5 wherein the therapeutic agent further comprises from about 10.5 to about 49 mol % galacturonic acid, from about 1.5 to about 60 mol % glucose and from about 9.5 to about 33% galactose based on mol % of total saccharide in the therapeutic agent.

16. The food composition according to claim 5 wherein the therapeutic agent comprises oligosaccharide or polysaccharide or both and the therapeutic agent has a saccharide content of:

| | Mol. % | |
|---|---|---|
| I. | 2-6 | rhamnose |
| | 41-49 | galacturonic acid |
| | 12-18 | glucose |
| | 16-22 | galactose |
| | 12-19 | arabinose, |
| II. | 3-8 | rhamnose |
| | 36-44 | galacturonic acid |
| | 2-7 | glucose |
| | 25-33 | galactose |
| | 17-25 | arabinose or |
| III. | 0.5-5 | rhamnose |
| | 11-22 | galacturonic acid |
| | 40-60 | glucose |
| | 10-19 | galactose |
| | 11-19 | arabinose, |

or mixtures thereof where mol % is based on total saccharide in the therapeutic agent having oligosaccharide and/or polysaccharide present therein.

17. The food composition according to claim 5 wherein the therapeutic agent is CVT-E002.

18. A method for providing therapeutic agent to a consumer comprising the steps of:
(a) formulating a food composition comprising a therapeutic agent, the therapeutic agent comprising an oligosaccharide, a polysaccharide or both, with the proviso that the therapeutic agent is not simultaneously free of oligosaccharide and free of polysaccharide comprising rhamnose and arabinose; and
(b) instructing the consumer to consume the food composition.

19. A method for reducing bitterness in a food composition comprising the step of formulating the food composition with a therapeutic agent, the therapeutic agent comprising an oligosaccharide, a polysaccharide or both, with the proviso that the therapeutic agent is not simultaneously free of oligosaccharide and free of polysaccharide comprising rhamnose and arabinose.

20. The method for reducing bitterness in a food composition according to claim 19 wherein the food composition is a tea beverage with catechins.
